(19) United States
(12) Patent Application Publication
(10) Pub. No.: US 2006/0184076 A1
(43) Pub. Date: Aug. 17, 2006

(54) Ultrasonic device and method for treating stones within the body

(76) Inventors: Robert P. Gill, Mason, OH (US); James W. Voegele, Cincinnati, OH (US); William Bruce Weisenburgh II, Maineville, OH (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 11/290,766

(22) Filed: Nov. 30, 2005

Related U.S. Application Data
(60) Provisional application No. 60/632,016, filed on Dec. 1, 2004.

(51) Int. Cl. A61H 1/00

(52) U.S. Cl. 601/3; 600/2

(57) ABSTRACT

A system and method to be used in ultrasonic lithotripsy of a stone in a ureter, the system including a catheter having a probe tip capable of transmitting and receiving ultrasonic energy. The catheter can include an inflatable balloon adjacent to the probe tip, the balloon capable of pooling some urine in the ureter to be used as an ultrasonic transmission media. The ultrasonic probe is connected to a source of energy capable of driving the probe tip to deliver ultrasonic energy of a high frequency and relatively low energy to image a stone. Then the probe can be connected to a source of energy capable of driving the probe to deliver a low frequency, high energy ultrasonic to disintegrate the stone.

### CROSS REFERENCE TO RELATED APPLICATION

The present application claims the priority benefit of U.S. provisional patent application Ser. No. 60/632,016, filed on Dec. 1, 2004, which is incorporated herein by reference in its entirety.

This application is related to U.S. patent application Ser. No. ______, attorney docket END-5485USNP, filed concurrently herewith.

### FIELD OF THE INVENTION

The present invention relates to apparatus and method to ultrasonically image and break apart a stone in the ureter.

### BACKGROUND OF THE INVENTION

Known ultrasound medical systems and methods include using ultrasound imaging of patients to identify patient tissue for medical treatment and include using ultrasound to medically destroy identified patient tissue by heating the tissue. Imaging is done at lower power and medical treatment is done at higher power. Low power imaging ultrasound will not medically affect patient tissue. High power medical-treatment ultrasound, when focused at a focal zone a distance away from the ultrasound source, will substantially medically affect patient tissue in the focal zone. However, focused medical-treatment ultrasound will not substantially medically affect patient tissue outside the focal zone such as patient tissue located between the source and the focal zone.

In one known example, a transducer assembly includes a single ultrasound transducer having a single transducer element, or an array of transducer elements acting together, to ultrasonically image the patient and to ultrasonically ablate identified patient tissue. It is known to convert ultrasound imaging data into temperature imaging data for ultrasound-treated patient tissue to monitor the ultrasound treatment. A known transducer element includes a transducer element having a concave shape or an acoustic lens to focus ultrasound energy. A known array of transducer elements includes a planar, concave, or convex array of transducer elements to focus ultrasound energy. A known array of transducer elements includes an array whose transducer elements are electronically or mechanically controlled together to steer and focus the ultrasound emitted by the array to a focal zone (which may be large or which may be as small as, for example, a grain of rice) to provide three-dimensional medical ultrasound treatment of patient tissue. In some applications, the transducer is placed on the surface of patient tissue for ultrasound imaging and/or ultrasound medical treatment of areas within the patient tissue. In other applications, the transducer is surrounded with a balloon, which is expanded to contact the surface of patient tissue by filling with a fluid such as a saline solution to provide acoustic coupling between the transducer and the patient tissue.

Known ultrasound medical systems and methods include deploying an end effector having an ultrasound transducer outside the body to break up kidney stones inside the body, endoscopically inserting an end effector having an ultrasound transducer in the colon to medically destroy prostate cancer, laparoscopically inserting an end effector having an ultrasound transducer in the abdominal cavity to medically destroy a cancerous liver tumor, intravenously inserting a catheter end effector having an ultrasound transducer into a vein in the arm and moving the catheter to the heart to medically destroy diseased heart tissue, and interstitially inserting a needle end effector having an ultrasound transducer needle into the tongue to medically destroy tissue to reduce tongue volume to reduce snoring. Known methods for guiding an end effector within a patient include guiding the end effector from x-rays, from MRI images, and from ultrasound images obtained using the ultrasound transducer. Known ultrasound imaging includes Doppler ultrasound imaging to detect blood flow, and a proposed known use of ultrasound includes using an ultrasound transducer outside the body to stop internal bleeding (by sealing ruptured blood vessels) of a patient brought to an emergency room of a hospital.

To treat stones in the human body there have been two approaches; intracorporeal, in the body and extra-corporeal, outside the body. Extra-corporeal has the benefit of being minimally invasive. The extra-corporeal approach involves imaging through the body with fluoroscopic techniques or with other imaging techniques and then once a stone is located, focusing an ultrasonic shock wave onto the stone to break the stone apart. In some cases the resulting stone fragments can pass out of the ureter.

For stones in the ureter, there are substantial limitations to the use of extra-corporeal shock wave lithotripsy (ESWL) techniques. Ureter stones in some portions of the ureter can be difficult to image because of interfering structure in the body. Similarly extra-corporeal techniques may not work for heavy patients at or above 300 pounds. Near this weight and above, it may not be possible to focus the ultrasonic energy to reach a stone. ESWL can also be complicated in cases where a patient has a pre-existing pulmonary or cardiac problem as shock waves can cause dysrhythmias. Another limitation of ESWL can be on larger stones and persistent steinstrasse. The American Urology Association recommends against ESWL for stones larger than 2 centimeters.

Extra-corporeal shock wave techniques may also not be effective for some stone compositions. ESWL may not work well for stones of calcium monohydrate, calcium phosphate and cystine. In some cases ESWL will also still require an internal basket to be inserted in the bladder or ureter to capture larger stone fragments.

It is also known to treat stones in the ureter with intracorporeal techniques. Intracorporeal lithitripsy (IL) techniques use external techniques to locate a stone and then go inside the body to fragment and remove ureter calculi. IL can be used for larger stones, those found in the lower ureter or stones impacted in the upper ureter. One prior art approach to IL is transurethral lithotripsy. Transurethral lithotripsy involves using a fiber optic ureterscope to place an ultrasonic, electromechanical or pneumatic probe adjacent to a stone. The ureterscope is used to guide the placement of the probe through the bladder and up the ureter. Once placed, the probe can be driven to fracture the stone. Problems with this technique include size and rigidity of the probe which generally limit applications to stones in the lower portion of the ureter. The technique can also cause unpredicted movement of the stone, which can lead to tissue damage.

Electrohydraulic lithotripsy is another prior art technique. In electrohydraulic lithotripsy a probe contacts a stone and electric spark created plasma induces shock waves that fracture the stone. Potential problems with electrohydraulic lithotripsy include heating, unpredictable stone movement and potential tissue damage to the ureter.

Another intracorporeal lithotripsy technique involves the use of lithotripsy lasers. Quartz fibers are placed in contact with the stone and laser energy causes thermal expansion that induces fragmentation of the stone. Problems with laser lithotripsy can include tissue damage, and heat. It is also possible to drill through a stone without fracturing it. An additional consideration is that the laser units and fibers can be expensive.

Another problem with prior art lithotripsy using internal imaging is with the ability to image the stone. Often the visual field using fiber optic scopes can be obscured and there is no depth of field. With poor imaging, it is possible to actually push the stone up the ureter with the probe because an operator cannot see the stone. Such unplanned movement of the stone is undesirable as it can lead to chasing a moving target or worse injury to the wall of the ureter. Another problem with transurethral lithotripsy has been that these procedures have several risk factors that typically require the procedure to take place on an inpatient basis and with the use of a full surgical suite. These risk factors include the risks associated with the use of general anesthetic, the risk of perforations to the ureter wall, and the need to be able to place a stent. Further, current techniques typically require a fluoroscope to perform the initial imaging and fluoroscopes are an expensive piece of medical equipment typically only available within a surgical suite.

It can be seen then that there is a need for an improved apparatus and method to treat stones in the ureter and elsewhere. There is a need for improved apparatus that will reduce the risks of lithotripsy procedures to enable lithotripsy outside the surgical suite. This invention addresses these needs.

### BRIEF SUMMARY OF THE INVENTION

The present invention relates to an apparatus for use inside or outside a surgical suite and to be used in ultrasonic lithotripsy of a stone in a ureter. The apparatus includes a catheter having a probe tip capable of transmitting and receiving ultrasonic energy. The apparatus can also include an inflatable balloon adjacent to the probe tip and a source of energy capable of driving the probe tip to deliver imaging ultrasonic energy of a high frequency and relatively low energy to image the stone. The apparatus can include a monitor capable of displaying an image of the stone. The source of energy is capable of driving the probe to deliver a second ultrasonic energy level of lower frequency and higher energy than the imaging ultrasonic energy to fracture the stone. The procedure may not require a fluoroscope or other external imaging.

In another aspect of the invention the inflatable balloon can cause pooling of urine fluid or saline solution in the ureter such that the pooled fluid can act as a medium to transmit ultrasonic energy from the probe to the stone. Reduction or disintegration of the stone occurs in part because of ultrasonic cavitation in the fluid surrounding the stone.

In a further aspect of the invention, a method of performing ultrasonic lithitripsy is disclosed including the steps of placing a catheter having an ultrasonic probe in the ureter adjacent to a stone and using an imaging ultrasonic energy to drive the probe to image the stone. The next step can be using a second source of ultrasonic energy to drive the probe to fracture the stone.

The present invention is useful in open or endoscopic surgeries as well as robotic-assisted surgeries.

Further features and advantages of the present invention will become readily apparent from the following detailed description, the accompanying drawings, and the appended claims.

### BRIEF DESCRIPTION OF THE FIGURES

FIG. 1 shows a view of the system components of one aspect of the invention in use;

FIG. 2a and 2b show the tip of on aspect of the invention presented to a stone;

FIG. 3 shows a sectional view of a portion of the invention during a portion of the procedure; and

FIG. 4 shows a block diagram of the steps of the method.

### DETAILED DESCRIPTION OF THE INVENTINON

Before explaining the present invention in detail, it should be noted that the invention is not limited in its application or use to the details of construction and arrangement of parts illustrated in the accompanying drawings and description. The illustrative embodiments of the invention may be implemented or incorporated in other embodiments, variations and modifications, and may be practiced or carried out in various ways. Furthermore, unless otherwise indicated, the terms and expressions employed herein have been chosen for the purpose of describing the illustrative embodiments of the present invention for the convenience of the reader and are not for the purpose of limiting the invention.

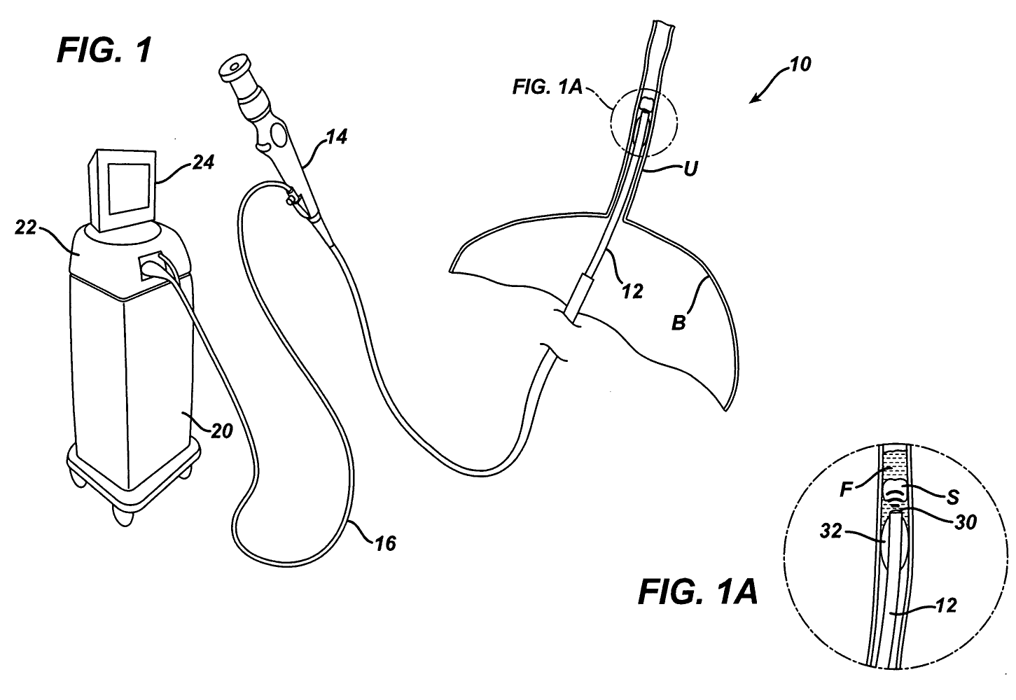

The features of the invention are set forth with particularity in the appended claims. The invention itself, however, both as to organization and methods of operation, together with further objects and advantages thereof, may best be understood by reference to the following description, taken in conjunction with the accompanying drawings in which FIG. 1 shows the entire system 10. A catheter ultrasonic (U/S) device 12 can be threaded through the bladder B and introduced to the ureter U using a cystoscope 14. A wire 16 can connect the catheter ultrasonic (U/S) device 12 to a source 20 of energy. For example, source 20 could be a source of electrical power used to drive a piezio-electric crystal in the catheter U/S device 12. Ultrasonic device 12 may be a transducer array as disclosed in U.S. Pat. Nos. 6,049,159; 6,050,943; and 6,120,452; all of which are incorporated herein by reference. The catheter U/S device 12 can be capable of delivering U/S energy in the frequency range of at least 0.1 to 2.0 megahertz. The energy source 20 can also include a computer 22 capable of analyzing U/S energy reflected back to the catheter U/S device 12 and a monitor 24 capable of displaying U/S images.

The enlargement 1A in FIG. 1 shows that the catheter U/S device 12 includes a transducer probe tip 30 capable of transmitting U/S energy to a stone S and of receiving reflected U/S energy from the stone S and surrounding structure. A catheter balloon 32 can block at least a portion of the urine fluid F. The urine fluid F can act as a media to transmit U/S energy from said transducer tip 30 to said stone S.

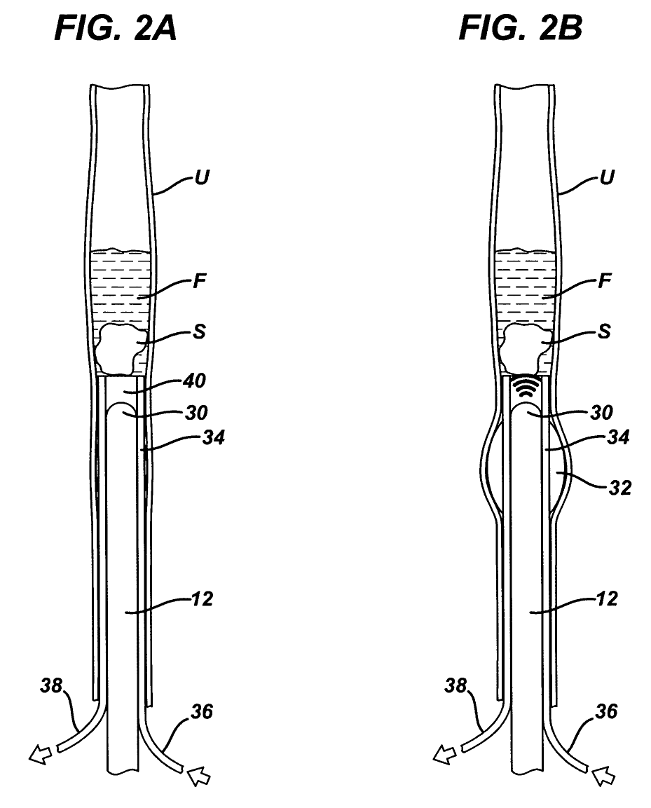

FIGS. 2a and 2b disclose the probe tip 30 of the catheter U/S device 12. The probe tip 30 can be inside a catheter sheath 34 which can include a source 36 of saline irrigation fluid and a drain 38 to carry saline and/ or urine from the ureter U. The catheter U/S device 12 can also include a coupling gel 40. FIG. 2b shows the balloon 32 inflated, which can trap some urine fluid F to act as a medium to transmit U/S energy. Irrigation saline solution can also be trapped to be used as a medium to transmit U/S energy. Fluids can be given to the patient prior to the procedure to augment urine available.

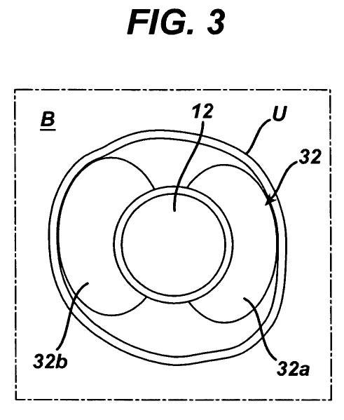

FIG. 3 shows a cross section of the catheter U/S device 12 through balloon 32. The balloon 32 can consist of two lobes 32a and 32b, whose volume can be controlled, and which can allow some urine fluid F to pass through the ureter U to the bladder B. The lobes 32a and 32b can allow some urine fluid F to pass to prevent urine fluid F backing up into the kidney, not shown. The balloon 32 is an optional feature and in some cases may not be needed.

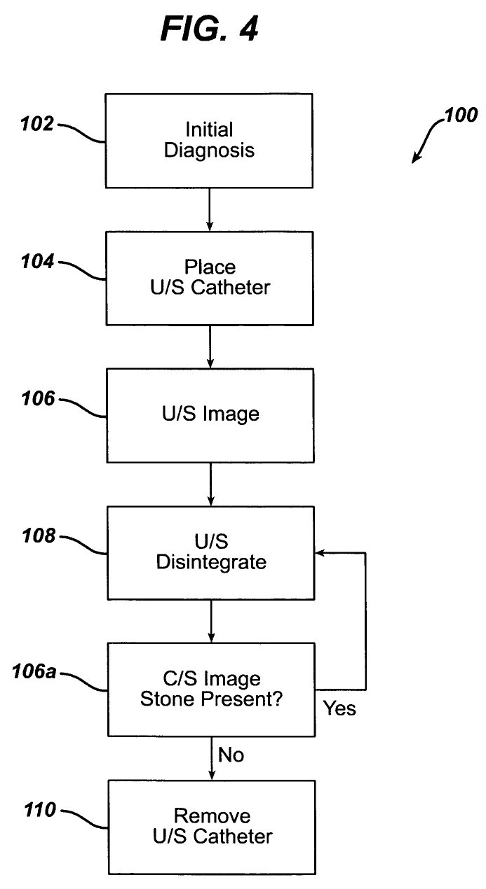

FIG. 4 shows the overall steps of the method 100 of use of the apparatus of FIGS. 1-3. The method can include an initial step of diagnosis 102 to determine that the method 100 would be appropriate for a patient and to locate in general where a stone may be relative to the ureter U. Once the initial diagnosis 102 has determined the method 100 is appropriate, placement 104 of the catheter U/S device 12 occurs. The catheter U/S device 12 is guided through the bladder B and into the ureter U. The cytoscope 14 can be used during the initial presentation of the catheter U/S device 12 through the bladder to the ureter. A traditional lighted fiberoptic cystoscope can be used to guide the visual placement through the bladder and identify the ureter junction. Once the U/S catheter device 12 is in the ureter and close to the stone, the balloon 32 can be expanded to trap urine fluid F and saline fluid can be provided through irrigation source 36. Air to expand the balloon 32 would be provided through an air channel (not shown) in the catheter 12.

Once the U/S catheter device 12 is in place in the ureter, the power source 20 can be turned on and the computer 22 set to provide high frequency, lower energy U/S. Reflected U/S energy will create an image on monitor 24. Based on the initial image on monitor 24, the catheter U/S device 12 can be adjusted to optimize the position and distance from the probe tip 30 to stone S. During imaging some urine fluid F can pass by the balloon 32 to prevent urine fluid F from backing into the kidney. The high frequency imaging energy can be provided in an adjustable frequency range of approximately 1 to 5 megahertz depending upon depth of field and material.

Once imaging has resulted in an optimal probe placement stone U/S disintegration 108 can begin. The computer 22 is reset so that the source 20 supplies low frequency high energy ultrasonic energy capable of causing cavitation in fluids adjacent the stone S. Cavitation of fluids will lead to fracture, reduction or disintegration of a stone. The low frequency will be in a range of 0.1 to 2.0 megahertz with an energy level on the order of 100 times greater than that required to image. Such a high level of energy can cause cavitation in the urine fluid F and it is the cavitation that will primarily lead to the disintegration of the stone S. During the fracture 108 step the irrigation saline fluid can carry away small bits of material as required through drain 38. During the application of high energy U/S the process may not be observed through fiber optics, but a technician can do a repeat image 106a to check on the progress of the stone break up. All that is required to repeat imaging is to reset the power to the probe tip 30 to generate the high frequency low energy U/S through the probe tip 30. Once the stone S is satisfactorily reduced in size by the cavitation, the U/S catheter device 12 can be removed 110.

It will be recognized that equivalent structures may be substituted for the structures illustrated and described herein and that the described embodiment of the invention is not the only structure which may be employed to implement the claimed invention. As one example of an equivalent structure which may be used to implement the present invention, though described in terms of a piezio-electric crystal supplying transferring U/S energy to reduce fragment or disintegrate the stone, it will be understood that any form of energy could be used. The energy to fracture could be supplied by well known means including shock wave, spark gap, impact, optical, laser or any other means. In some cases, a source of high frequency U/S might be used to position the probe 30 in an ideal position and then that U/S source could be slid out of the catheter 34 and a different source could be slid in to the ideal location to fracture the stone. Though shown using urine fluid F as a coupling media it will be understood that the coupling media can be a urine, a mixture of urine and saline irrigation solution or a mixture of any fluid capable of transmitting the U/S energy for imaging and fracture of the stone. Though ranges of U/S frequency and energy have been cited it will be understood that any range of U/S that allows for imaging and fracture of a stone could be used. Further while the process is described in terms of application to the ureter, those skilled in the art will see applications of the apparatus and method to other areas within the body where stones can be found.

While the present invention has been illustrated by description of several embodiments, it is not the intention of the applicant to restrict or limit the spirit and scope of the appended claims to such detail. Numerous variations, changes, and substitutions will occur to those skilled in the art without departing from the scope of the invention. Moreover, the structure of each element associated with the present invention can be alternatively described as a means for providing the function performed by the element. Accordingly, it is intended that the invention be limited only by the spirit and scope of the appended claims.

What is claimed is:

1. A system to be used in ultrasonic lithotripsy of a stone in a body, said system including;
a catheter including a probe tip capable of transmitting and receiving ultrasonic energy;
an inflatable balloon adjacent to said probe tip;
a source of energy capable of driving said probe tip to deliver ultrasonic energy of a first frequency to said stone and of receiving reflected ultrasonic energy from said stone;
a monitor capable of displaying an image of said stone in response to said reflected ultrasonic energy; and
said source of energy capable of driving said probe to deliver a second ultrasonic energy of higher frequency than said first ultrasonic energy.

2. A method of performing ultrasonic lithitripsy including the steps of:
placing a catheter having an inflatable element and ultrasonic probe in a body adjacent to a stone;
inflating the inflatable element;
using a first source of ultrasonic energy to drive the probe to image the stone; and
using a second source ultrasonic energy to drive the probe to disintegrate the stone.
